(19) United States
(12) Patent Application Publication
(10) Pub. No.: US 2006/0022927 A1
(43) Pub. Date: Feb. 2, 2006

(54) Display driver circuits having gray scale voltage amplifiers with variable drive capability

(76) Inventors: Jae-hyuck Woo, Gyeonggi-do (KR); Jae-goo Lee, Gyeonggi-do (KR)

Correspondence Address: MYERS BIGEL SIBLEY & SAJOVEC, PO BOX 37428, RALEIGH, NC, 27627, US

(21) Appl. No.: 11/190,253

(22) Filed: Jul. 26, 2005

(30) Foreign Application Priority Data
Jul. 27, 2004 (KR) 2004-58792

(51) Int. Cl. G09G 3/36

(52) U.S. Cl. 345/89

(57) ABSTRACT

Display driver circuits include an output selector circuit having an output port electrically coupled to a plurality of display data lines and a first input port electrically coupled to a first bus. An amplifier control circuit is also provided. This control circuit includes a plurality of amplifiers, which are programmable to have different current sourcing characteristics. The control circuit is configured to drive each of a plurality of signal lines in the first bus with different gray scale voltages provided by the plurality of amplifiers. The output selector also has a second input port configured to receive digital display data. This digital display data is also provided to the amplifier control circuit.

### REFERENCE TO PRIORITY APPLICATION

This application claims priority to Korean Patent Application No. 2004-58792, filed Jul. 27, 2004, the disclosure of which is hereby incorporated herein by reference.

### FIELD OF THE INVENTION

The present invention relates to integrated circuit drivers and, more particularly, to display driver circuits.

### BACKGROUND OF THE INVENTION

Conventional liquid crystal display (LCD) driver circuits may drive display data lines with gray scale voltages using a plurality of gamma amplifiers. However, to account for the possibility that many display data lines may need to receive the same gray scale voltage in parallel during a display line driving interval (e.g., when pixels in a row of the display are receiving display data), each of the plurality of gamma amplifiers may need to support the same high level drive capability for each of the gray scale voltages. This support of the same drive capability may result in excessive power consumption.

### SUMMARY OF THE INVENTION

The present invention provides a circuit and method for controlling the driving current of an amplifier in response to the number of channels to be driven.

According to an embodiment of the present invention, there is provided an amplifier control circuit including a select circuit, a counter, and at least one amplifier. The select circuit generates an output signal in response to an input signal. The counter outputs a control signal in response to the output signal of the select circuit. The amplifier is connected to the output terminal of the counter. The current driving capability of the amplifier is controlled in response to the control signal. The select circuit is a decoder or a multiplexer. The amplifier control circuit further includes a reset signal generating circuit, which generates a first reset signal for resetting the select circuit. The reset signal generating circuit further generates a second reset signal for resetting the counter. When the counter is an N-bit counter, the control signal is composed of upper bits including the MSB of the N bit counter. The counter generates the control signal in response to variations in the state of the output signal of the select circuit.

The amplifier control circuit further includes a shift register block, which receives input data and shifts the received input data by a predetermined number of bits to generate the input signal. The amplifier control circuit further includes a non-load detector, which controls the activation and deactivation of the amplifier in response to the output signal of the select circuit.

According to another embodiment of the present invention, there is provided an amplifier control circuit including a plurality of select circuits, a plurality of counters, and a plurality of amplifiers. Each of the plurality of select circuits generates an output signal in response an input signal. Each of the plurality of counters outputs a control signals in response to a variation in the state of the output signal of the corresponding select circuit. The current driving capabilities of the plurality of amplifiers are controlled in response to the control signals output from the corresponding counters. The amplifier control circuit further includes a plurality of non-load detectors each of which controls the activation and deactivation of at least one amplifier among the plurality of amplifiers in response to the output signal of the corresponding select circuit. The plurality of amplifiers respectively receives corresponding gray-scale voltages.

According to another embodiment of the present invention, there is provided a method for controlling an amplifier including generating an output signal in response to an input signal, counting the number of variations in the state of the output signal of the select circuit and outputting a control signal based on the count result and controlling current driving capability of at least one amplifier in response to the control signal. The control signal is composed of a predetermined number of bits including the MSB of data representing the number of variations in the state of the output signal of the select circuit, counted by the counter.

According to another embodiment of the present invention, there is provided a method for controlling an amplifier including generating output signals in response to an input signal, counting the number of variations in the states of the output signals of the corresponding select circuits and outputting control signals including a predetermined number of bits in response to the counted results, and controlling the current driving capabilities of a plurality of amplifiers in response to the control signals output from the corresponding counters.

### BRIEF DESCRIPTION OF THE DRAWINGS

FIG. 1 is a block diagram of a system including an amplifier control circuit according to an embodiment of the present invention;

FIG. 2 is a block diagram of the amplifier control circuit according to a first embodiment of the present invention;

FIG. 3 is a block diagram of the amplifier control circuit according to a second embodiment of the present invention; and

FIG. 4 is a block diagram of the amplifier control circuit according to a third embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms, and should not be construed as being limited to the embodiments set forth herein; rather, these embodiments are provided so that this disclosure will be thorough and complete, and will fully convey the scope of the invention to those skilled in the art. Throughout the drawings, like reference numerals refer to like elements.

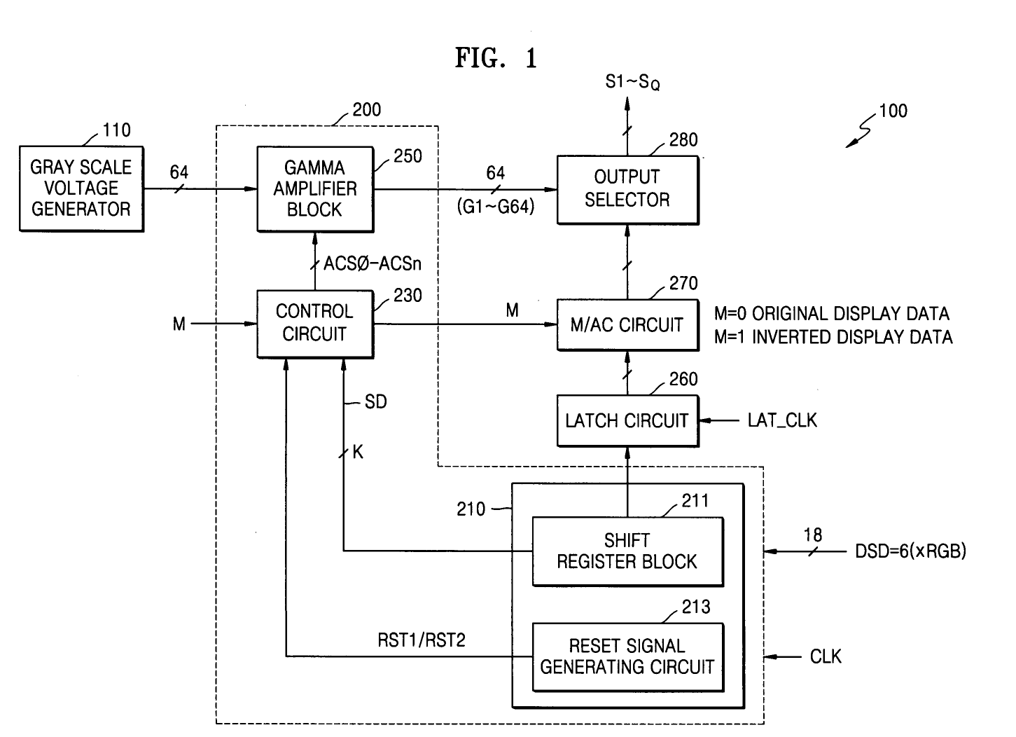

FIG. 1 is a block diagram of a system 100 including an amplifier control circuit 200 according to an embodiment of the present invention. The system 100 can be a TFT-LCD driver, particularly a source driver. Referring to FIG. 1, the system 100 includes a gray-scale voltage generator 110, the amplifier control circuit 200, a latch circuit 260, a polarity control circuit 270, and an output selector 280.

The gray-scale voltage generator 110 generates a plurality of gray-scale voltages (for example, 64 gray-scale voltages) and outputs them to a gamma amplifier block 250. The amplifier control circuit 200 senses (or counts) the number of channels to be driven and controls the current driving capability of each of the gamma amplifiers of the gamma amplifier block in response to the number of channels. The latch circuit 260 receives data in units of 18 bits (6 bits (gray scale data)×3 (red, green and blue)) from a logic circuit 210 in response to a latch clock signal LAT_CLK, and latches the received data.

The polarity control circuit 270 controls the polarity of display data in response to a polarity control signal M. When the polarity control signal M is 0 (or low), for example, the polarity control circuit 270 transmits the display data output from the latch circuit 260 to the output selector 280. When the polarity control signal M is 1 (or high), the polarity control circuit 270 receives the display data output from the latch circuit 260, inverts the polarity of the received display data, and then transmits the display data having the inverted polarity to the output selector 280. The output selector 280 selects one of the gray-scale voltages output from the gamma amplifier block 250 in response to the display data output from the polarity control circuit 270, generates analog data voltages corresponding to the display data, buffers the analog data voltages, and then outputs the buffered analog data voltages to data lines S1 through S_{Q} of an LCD panel. That is, the output selector 280 drives the data lines S1 through S_{Q}. Accordingly, the output selector 280 has the functions of a digital-to-analog converter and an output buffer.

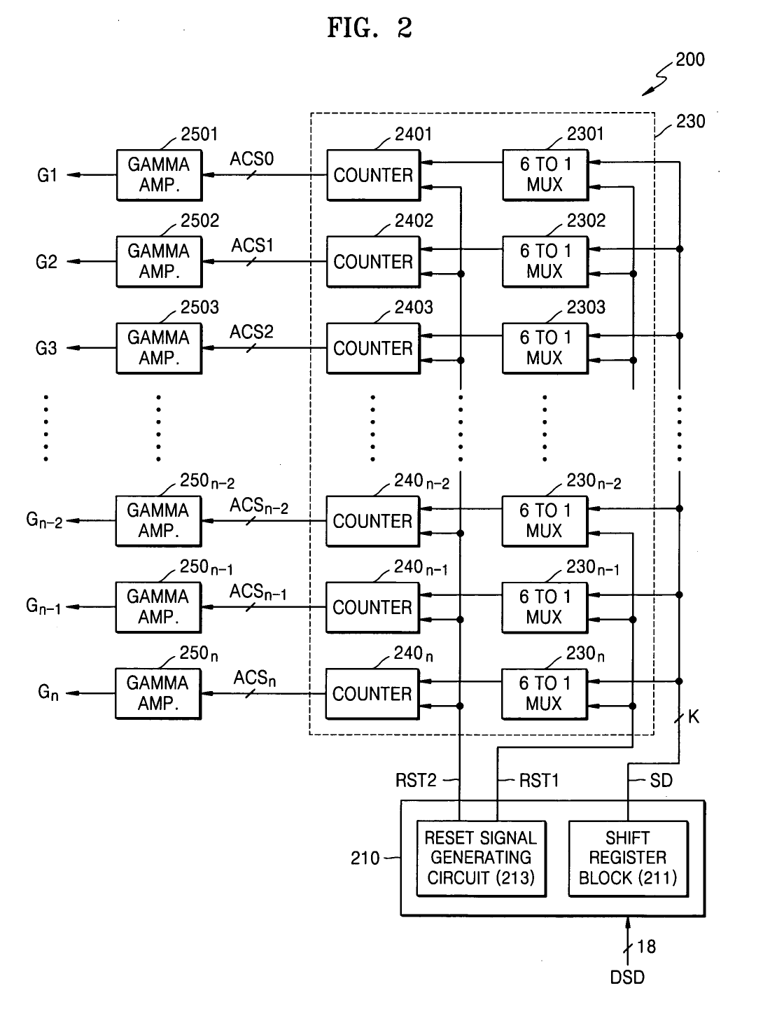

FIG. 2 is a block diagram of the amplifier control circuit 200 according to a first embodiment of the present invention. Referring to FIGS. 1 and 2, the amplifier control circuit 200 includes the logic circuit 210, a control circuit 230, and the gamma amplifier block 250. The logic circuit 210 includes a shift register block 211 and a reset signal generating circuit 213. The shift register block 211 includes a plurality of shift registers (not shown) connected in series. The shift register block 211 receives X-bit (X is a natural number) serial display data DSD, shifts the received X-bit serial display data DSD to the left or right by a predetermined number of bits in response to a clock signal CLK, and outputs shifted K-bit (K is a natural number) data SD.

The reset signal generating circuit 213 generates a plurality of reset signals RST1 and RST2 based on the clock signal CLK and/or the serial display data DSD. The reset signal RST1 is a pulse signal for resetting a plurality of select circuits 2301 through 230n. Preferably, the reset signal RST1 is generated before the shifted K-bit data SD is input to the plurality of select circuits 2301 through 230n. The reset signal RST2 is a pulse signal for resetting a plurality of counters 2401 through 240n, and is preferably synchronized with a horizontal synchronization signal. The control circuit 230 includes the plurality of select circuits 2301 through 230n and the plurality of counters 2401 through 240n. Here, n is a natural number. The plurality of select circuits 2301 through 230n can be decoders or multiplexers.

The plurality of select circuits 2301 through 230n respectively output signals activated in response to the shifted K-bit (K=6, for example) data SD output from the shift register block 211 to the corresponding counters 2401 through 240n. The plurality of counters 2401 through 240n can be N-bit counters. The plurality of counters 2401 through 240n count the number of variations in the states of the output signals of the corresponding select circuits 2301 through 230n, and output corresponding control signals ACS0 through ACSn to corresponding amplifiers 2501 through 250n, respectively.

The number of bits of each of the plurality of counters 2401 through 240n depends on the number of channels. Preferably, the number represented by the number of bits (2⁹ when the number of bits is 9) is identical to or larger than the number of channels. Each of the control signals ACS0 through ACSn can be composed of upper bits including the most significant bit (MSB) of the bits of each of the N-bit counters 2401 through 240n.

The gamma amplifier block 250 includes the plurality of amplifiers 2501 through 250n (n is a natural number). The plurality of amplifiers 2501 through 250n control their current driving capabilities in response to the control signals ACS0 through ACSn output from the counters 2401 through 240n, which correspond to gray-scale voltages among the plurality of gray-scale voltages output from the gray-scale voltage generator 110. Accordingly, the plurality of amplifiers 2501 through 250n can respectively drive a plurality of data lines (or channels) in response to the control signals ACS0 through ACSn.

The operation of the amplifier control circuit 200 according to the present invention will now be explained in detail with reference to FIGS. 1 and 2. The shift register block 211 receives 18-bit serial data DSD and outputs shifted 6-bit data SD. The select circuit 2301 is activated (to a high level or 1) in response to shifted 6-bit data (SD=000000) and deactivated (to a low level or 0) in response to the reset signal RST1. The select circuit 2302 is activated in response to shifted 6-bit data (SD=000001) and deactivated in response to the reset signal RST1. The select circuit 230n is activated in response to shifted 6-bit data (SD=111111) and deactivated in response to the reset signal RST1. Each of the select circuits 2301 through 230n is comprised of a 6:1 multiplexer.

When the number of data lines S1 through S_{Q} is 396 (that is, there are 396 channels or loads), each of the plurality of counters 2401 through 240n is comprised of a 9-bit counter. Thus, data ranging from 000000000 through 110001100 is stored in each of the counters 2401 through 240n. Each of the control signals ACS0 through ACSn is composed of the upper 2 bits including the MSB of data stored in each of the 9-bit counters. When the shift register block 211 outputs data SD=000000₂ ten times during one period of the horizontal synchronization signal, the output signal of the select circuit 2301 is activated ten times. Accordingly, the counter 2401 stores 00001010 and outputs 00 to the amplifier 2501 as the control signal ACS0. The amplifier 2501 controls its current driving capability in response to the control signal ACS0=00 and outputs a signal G1 corresponding to the controlled current driving capability to the output selector 280. The signal G1 can drive a plurality of corresponding channels.

When the shift register block 211 outputs data SD=000001 128 times during one period of the horizontal synchronization signal, the output signal of the select circuit 2302 is activated 128 times. Accordingly, the counter 2401 stores 010000000 and outputs 01 to the amplifier 2502 as the control signal ACS1. The amplifier 2502 controls its current driving capability in response to the control signal ACS1=01 and outputs a signal G2 corresponding to the controlled current driving capability to the output selector 280. The signal C2 can drive a plurality of corresponding channels.

When the shift register block 211 outputs data SD=111111 256 times during one period of the horizontal synchronization signal, the output signal of the select circuit 2301 is activated 256 times. Accordingly, the counter 2401 stores 100000000 and outputs 10 to the amplifier 250n as the control signal ACS63. The amplifier 250n controls its current driving capability in response to the control signal ACS63=10 and outputs a signal G63 corresponding to the controlled current driving capability to the output selector 280. The signal G63 can drive a plurality of corresponding channels.

That is, the number of times that each of the plurality of select circuits 2301 through 230n are activated is determined based on corresponding 6-bit data SD. Accordingly, the 9-bit counters 2401 through 240n count the number of times that the signals output from the corresponding select circuits 2301 through 230n are activated, store data representing the count result, and respectively output the control signals ACS0 through ACSn each configured of 2 bits including the MSB of the stored data to the amplifiers 2501 through 250n.

That is, each of the plurality of 9-bit counters 2401 through 240n counts the number of channels to be driven (0 through 396) and outputs a control signal corresponding to the counted number of channels to the corresponding amplifier. Accordingly, the amplifiers 2501 through 250n control their current driving capabilities in response to the corresponding control signals ACS0 through ACSn. Table 1 represents the current driving capability of the amplifiers 2501 through 250n in response to the control signals ACS0 through ACSn.

TABLE 1

| ACS0 through ACSn | Current driving capability of amplifiers |
|---|---|
| 11 | Very large |
| 10 | Normal |
| 01 | Lower than normal |
| 00 | Very low or off |

Accordingly, the number of bits of each of the control signals ACS0 through ACSn can be increased when the current driving capability of the amplifiers 2501 through 250n is required to be more accurately controlled.

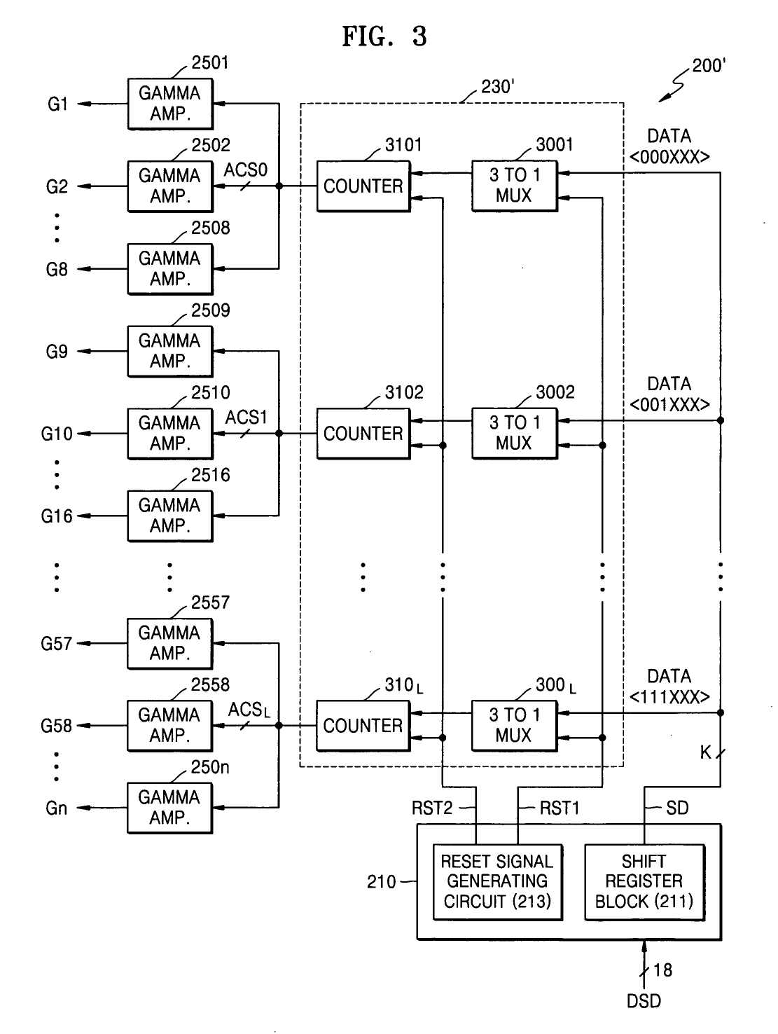

FIG. 3 is a block diagram of the amplifier control circuit 200′ according to a second embodiment of the present invention. The amplifier control circuit 200′ includes a plurality of select circuits 3001 through 300_{L}, a plurality of counters 3101 through 310_{L}, and a plurality of gamma amplifiers 2501 through 250n. Here, L is a natural number. The select circuits 3001 through 300_{L} respectively generate output signals in response to upper 3-bit data including the MSB of shifted K-bit (K is a natural number) data SD. The select circuits 3001 through 300_{L} are 3:1 multiplexers.

Each of the counters 3101 through 310_{L} is connected to the input terminals of 8 amplifiers. The output signal of the select circuit 3001 is activated in response to data 000XXX and deactivated in response to the reset signal RST1. The output signal of the select circuit 3002 is activated in response to data 001XXX and deactivated in response to the reset signal RST1. The output signal of the select circuit 300_{L} is activated in response to data 111XXX and deactivated in response to the reset signal RST1.

Accordingly, the counter 3101 counts the number of times that the output signal of the select circuit 3001 is activated, and outputs a control signal ACS0 in response to the count result to the plurality of amplifiers 2501 through 2508. The amplifiers 2501 through 2508 control their current driving capabilities in response to the control signal ACS0 and output signals G1 through G8 corresponding the controlled current driving capabilities to the output selector 280. The output selector 280 drives at least one channel S1 through S_{Q} in response to the signals G1 through G8 and the display data output from the polarity control circuit 270.

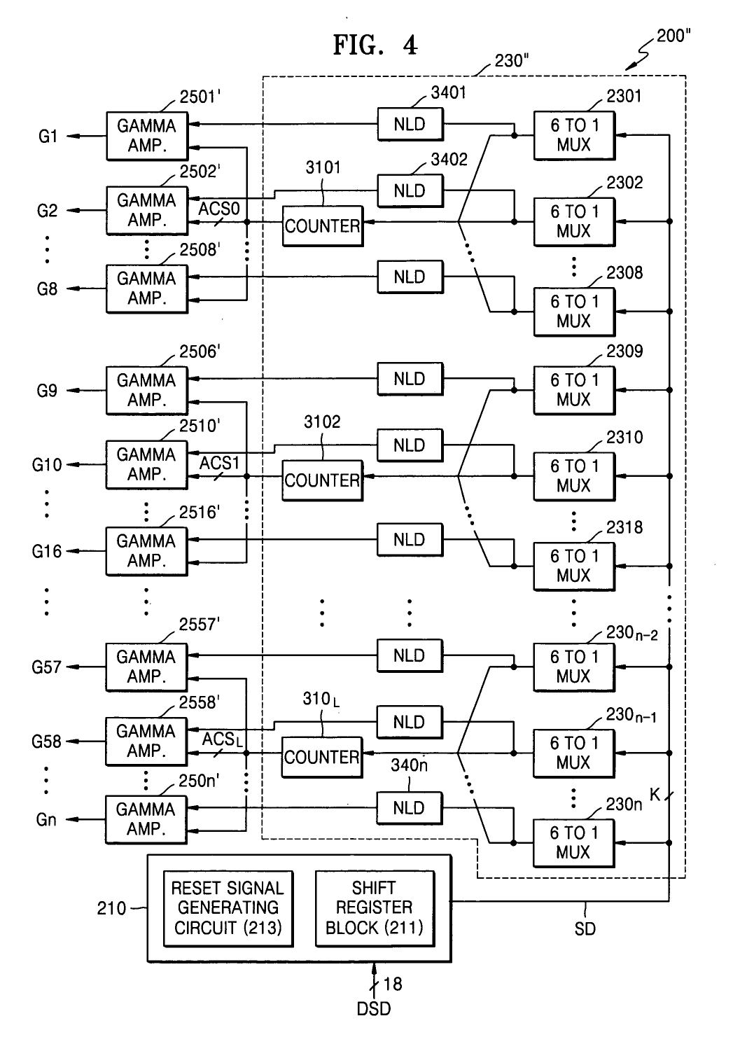

FIG. 4 is a block diagram of the amplifier control circuit 200″ according to a third embodiment of the present invention. Referring to FIG. 4, the control circuit 230″ includes a plurality of select circuits 2301 through 230n, a plurality of non-load detectors 3401 through 340n, and a plurality of counters 3101 through 310n. The plurality of non-load detectors 3401 through 340n detect variations in the output signals of the corresponding select circuits 2301 through 230n, and respectively output the detected results to corresponding amplifiers 2501′ through 250n′. Accordingly, the amplifiers 2501′ through 250n′ are turned off in response to the detected results, and thus unnecessary current consumed by the amplifiers 2501′ through 250n′ can be considerably reduced.

When shifted K-bit (K=6) data (SD=000000) is not input at all during one period of the horizontal synchronization signal, for example, the output signal of the select circuit 2301 is maintained in an deactivated state. Accordingly, the non-load detector 3401 outputs a control signal for turning off the amplifier 2501′ to the amplifier 2501′ in response to the output signal of the select circuit 2301, and thus the amplifier 2501′ is disabled in response to the control signal. However, when the shifted K-bit (K=6) data (SD=000000) is input more than once during one period of the horizontal synchronization signal, the output signal of the select circuit 2301 repeats activation and deactivation by the number of times that the data (SD=000000) is input.

Accordingly, the counter 3101 outputs a control signal ACS0 including one of 00, 01, 10 and 11 to the amplifiers 2501′ through 2508′ in response to the number of times that the data (SD=000000) is input. The amplifiers 2501′ through 2508′ control their current driving capabilities in response to the control signal ACS0, and output signals G1 through G8 to the output selector 280 in response to the control results.

Accordingly, as illustrated by FIGS. 1-2, a display driver circuit 100 includes an output selector circuit 280 having an output port electrically coupled to a plurality of display data lines (S1-SQ) and a first input port (e.g., 64-bit port) electrically coupled to a first bus, which is shown as a 64-bit bus carrying distinct gray voltages. The output selector circuit 280 also has a second input port configured to receive digital display data (DSD). An amplifier control circuit 200 (see, also 200′ and 200″ in FIGS. 3-4) is also provided. This amplifier control circuit 200 includes a plurality of amplifiers within a gamma amplifier circuit 250. These amplifiers (e.g., 2501-250n in FIG. 2) are programmable to have different current sourcing characteristics. The amplifier control circuit 200 is configured to drive each of a plurality of signal lines in the first bus with different gray scale voltages provided by the plurality of amplifiers. In particular, the amplifier control circuit 200 is configured to program the plurality of amplifiers with different current sourcing characteristics that reflect a degree to which each gray scale voltage (G1-G64) is selected by the output selector circuit 280. As illustrated by FIGS. 2-4, the amplifier control circuit 200 (200′ or 200″) includes a plurality of counters 2401-240n configured to generate a plurality of count values (ACS0-ACSn) that reflect the degree to which each of the different gray scale voltages is to be transferred to the plurality of display data lines S1-SQ during a horizontal display line driving interval. These Count values, which are received by the amplifiers, set the drive capability of each amplifier. In particular, a higher count value translates to an amplifier having a higher drive capability (e.g., more active drive transistors operating in parallel) and a lower count value translates to an amplifier having a lower drive capability.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A display driver circuit, comprising:
an output selector circuit having an output port electrically coupled to a plurality of display data lines and a first input port electrically coupled to a first bus; and
an amplifier control circuit comprising a plurality of amplifiers programmable to have different current sourcing characteristics, said amplifier control circuit configured to drive each of a plurality of signal lines in the first bus with different gray scale voltages provided by the plurality of amplifiers.

2. The driver circuit of claim 1, wherein said output selector has a second input port configured to receive digital display data; and wherein said amplifier control circuit is responsive to the digital display data.

3. The driver circuit of claim 1, further comprising a gray scale voltage generator electrically coupled to the plurality of amplifiers.

4. The driver circuit of claim 3, wherein said amplifier control circuit is configured to program the plurality of amplifiers with different current sourcing characteristics that reflect a degree to which each gray scale voltage is selected by said output selector circuit.

5. The driver circuit of claim 2, wherein said amplifier control circuit is configured to program the plurality of amplifiers with different current sourcing characteristics that reflect a degree to which each gray scale voltage is selected by said output selector circuit.

6. The driver circuit of claim 4, wherein said amplifier control circuit comprises a plurality of counters configured to generate a plurality of count values that reflect the degree to which each of the different gray scale voltages is to be transferred to the plurality of display data lines during a horizontal display line driving interval.

7. The driver circuit of claim 6, wherein the plurality of amplifiers are responsive to the plurality of count values.

8. An amplifier control circuit comprising:
a select circuit, which generates an output signal in response to an input signal;
a counter which outputs a control signal in response to the output signal of the select circuit; and
at least one amplifier which is connected to the output terminal of the counter, and the current driving capability of which is controlled in response to the control signal.

9. The amplifier control circuit of claim 8, wherein the select circuit is a decoder or a multiplexer.

10. The amplifier control circuit of claim 8, further comprising a reset signal generating circuit, which generates a first reset signal for resetting the select circuit.

11. The amplifier control circuit of claim 10, wherein the reset signal generating circuit further generates a second reset signal for resetting the counter.

12. The amplifier control circuit of claim 8, wherein, when the counter is an N-bit counter, the control signal is composed of upper bits including the MSB of the N bit counter.

13. The amplifier control circuit of claim 8, wherein the counter generates the control signal in response to a variation in the state of the output signal of the select circuit.

14. The amplifier control circuit of claim 8, further comprising a shift register block, which receives input data and shifts the received input data by a predetermined number of bits to generate the input signal.

15. The amplifier control circuit of claim 8, further comprising a non-load detector, which controls the activation and deactivation of the amplifier in response to the output signal of the select circuit.

16. An amplifier control circuit comprising:
a plurality of select circuits, which generate output signals in response an input signal;
a plurality of counters which output control signals in response to variations in the states of the output signals of the corresponding select circuits; and
a plurality of amplifiers whose current driving capabilities are controlled in response to the control signals output from the corresponding counters.

17. The amplifier control circuit of claim 16, further comprising a plurality of non-load detectors, each of which controls the activation and deactivation of at least one amplifier among the plurality of amplifiers in response to the output signal of the corresponding select circuit.

18. The amplifier control circuit of claim 16, wherein the plurality of amplifiers respectively receive corresponding gray-scale voltages.

19. A method for controlling an amplifier comprising:
using a select circuit, generating an output signal in response to an input signal;
using a counter, counting the number of variations in the state of the output signal of the select circuit and outputting a control signal based on the counted result; and
controlling the current driving capability of at least one amplifier in response to the control signal.

20. The method of claim 19, wherein the control signal is composed of a predetermined number of bits including the MSB of data representing the number of variations in the state of the output signal of the select circuit, counted by the counter.

21. A method for controlling an amplifier comprising:
generating output signals in response to an input signal;
counting the number of variations in the states of the output signals of the select circuits and outputting control signals including a predetermined number of bits in response to the count results; and
controlling the current driving capabilities of a plurality of amplifiers in response to the control signals output from the corresponding counters.
